(19) United States
(12) Patent Application Publication
(10) Pub. No.: US 2020/0275195 A1
(43) Pub. Date: Aug. 27, 2020

(54) IMPROVED SOUND TRANSDUCER

(71) Applicant: INSTITUT FÜR RUNDFUNKTECHNIK, Munich (DE)

(72) Inventor: Roman STUMPNER, Munich (DE)

(21) Appl. No.: 16/754,542

(22) PCT Filed: Oct. 11, 2017
(86) PCT No.: PCT/IB2017/056268

§ 371 Date: Apr. 8, 2020

(51) Int. Cl. H04R 1/28; H04R 1/10; H04S 7/00; H04R 5/033

(52) U.S. Cl. CPC H04R 1/2869; H04R 5/033; H04S 7/30; H04R 1/1091

(57) ABSTRACT

According to the present invention, an apparatus, a signal processing unit, data, a processing apparatus, a sound converter, a software product and a method are proposed. The apparatus is proposed for acoustic reproduction, wherein the apparatus is provided with a first electroacoustic sound transducer for generating a sound field, the first electroacoustic sound transducer having an input for receiving an electrical signal for generating the corresponding sound field, wherein the apparatus is characterized in that also a device is provided which is configured to enter into an acoustic interaction with the generated sound field of the first electroacoustic sound transducer in order to generate a modified sound field and wherein the modified sound field has a predetermined acoustic impedance value.

The present invention is directed at a device, a method, a signal processing unit, data for acoustic reproduction, a sound transducer, in particular a headphone or an earphone, and a software product for improving sound reproduction.

Problems with the reproduction of sound signals via headphones are known from the prior art, so that when sound events are emitted via headphones, under certain conditions these sound events are perceived by the human ear in a significantly different way as with sound sources that are distant from the ear such as loudspeakers. Despite the use of external ear transmission functions, spatial imaging errors (elevation angle) can occur if the sound source is in the median plane (imaginary plane perpendicular between the ears) of the listener. With such correlated signals, interaural levels and transit time differences are missing. Especially with sound sources located in front, the sound signals are often perceived as in the head or very close to the head (so-called in-head localization). The IHL often occurs in connection with a disturbing elevation (localization at the top of the head). So far, these problems can only be improved through technically complex optical support or through head tracking. Further imaging errors relate to the perceived volume of sound signals that are emitted via headphones. Headphones may be perceived as quieter than distant sound sources, even though the sound pressure level is the same. It has been shown that this so-called SLD effect (Sound pressure Loudness Divergence) always occurs together with the in-head localization.

The present invention is therefore based on the object of eliminating or at least reducing the above problems in order to achieve an improved sound reproduction.

This object is solved according to the invention based on one of the claims listed, in particular based on the following descriptions and figures.

According to a first aspect of the present invention, an apparatus for acoustic reproduction is proposed, the apparatus being provided with a first electroacoustic sound transducer for generating a sound field, the first electroacoustic sound transducer having an input for receiving an electrical signal for generating the corresponding sound field, wherein the apparatus is characterized in that a device is also provided which is configured to enter into an acoustic interaction with the generated sound field of the first electroacoustic sound transducer in order to generate a modified sound field and wherein the modified sound field has a predetermined acoustic impedance value.

According to a further aspect of the present invention, an apparatus is proposed, wherein the device is at least one acoustic resonator and/or at least one further electroacoustic sound transducer. An electroacoustic sound transducer is therefore generally proposed in accordance with the present invention either in cooperation with at least one further electroacoustic sound transducer or in cooperation with at least one resonator. For both of the aforementioned embodiment variants, an acoustic interaction is provided in order to generate a modified sound field, so that the modified sound field has a predetermined acoustic impedance value. Further alternatively, according to the invention it is provided that both of the aforementioned variants are configured to set different impedance values or variable impedance values for the modified sound field.

According to the invention, an apparatus according to one of the above alternative embodiments is proposed, wherein the first electroacoustic sound transducer and/or the further electroacoustic sound transducer is configured to receive an electrical signal based on an impedance information and to convert it into an acoustic signal so that the modified acoustic field has a predetermined acoustic impedance value through the corresponding acoustic interaction.

According to a further advantageous aspect of the present invention, an apparatus is proposed, wherein the at least one acoustic resonator is designed as a recess, hole or as a Helmholtz resonator, those being implemented in particular on the housing of the device, in particular in the inner and/or outer housing area.

Furthermore, an apparatus of the above type is proposed according to the invention, wherein the first electroacoustic sound transducer and/or the further electroacoustic sound transducer and/or the acoustic resonator are controllable by a corresponding electrical signal in order to set different acoustic impedance values in the modified sound field. In this case, control can take place either directly via the electrical audio signal to be fed in and/or via a separate signaling.

Further advantageously, one of the apparatus of the above type is proposed, wherein the apparatus has a measuring unit, in particular a microphone for measuring a sound field parameter in order to be able to derive a given impedance value in the sound field therefrom, to enable the generation of a subsequent electrical adaptation signal. It is expressly pointed out here that one or more of the embodiments proposed according to the invention are either configured to receive an already prepared signal for setting an acoustic impedance value and to generate the corresponding modified sound field, or to actively carry out a measurement via a control loop in order to measure a current impedance value in the sound field in order to implement subsequent readjustment by generating a suitable signal.

It is further advantageous that one of the above apparatus according to the invention is designed as headphones or as earphones, in particular a corresponding housing can be provided for accommodating the device according to the invention and can be designed as a helmet.

Further advantageously, an apparatus is proposed in which the position and/or the orientation of the first electroacoustic sound transducer and/or of the further electroacoustic sound transducer and/or of the acoustic resonator is designed to be changeable and in particular can be changed by a suitable electrical signal and adjusted if necessary. In particular, variability in the position and/or orientation of a sound transducer or resonator is protected. Furthermore, in the case of a resonator, the frequency response and/or the oscillating mass can be designed to be controllable.

According to a further aspect, a signal processing unit for processing signals for acoustic reproduction is proposed, which is characterized in that the signal processing unit is configured to process a further signal for acoustic interaction with a first sound field, based on a first signal which is provided for generating the first sound field, to generate a modified sound field, wherein the modified sound field has a predetermined acoustic impedance value.

Further advantageously, a signal processing unit is proposed, the signal processing unit providing a factor based on at least one sound pressure signal and/or one sound velocity of the first signal to generate a modified sound field, wherein the modified sound field has a predetermined acoustic impedance value.

Further advantageously, a signal processing unit is proposed, wherein the sound pressure signal and/or the sound velocity is derived by a measurement, particularly from of at least one microphone.

Further advantageously, a signal processing unit is proposed, wherein the signal processing unit is configured to process an impedance signal for the impedance signal being providable to a sound transducer.

Further advantageously, a signal processing unit is proposed, wherein the modified sound field has a temporally predetermined variable acoustic impedance value.

Further advantageously, a signal processing unit is proposed, wherein the signal processing unit is configured to process further relevant acoustic parameters, in particular geometric parameters of a headphone or an earphone, in order to set the predetermined acoustic impedance value for the modified sound field.

Further advantageously, data for acoustic reproduction is proposed, characterized in that the data has data elements for acoustic interaction with a first sound field, wherein the data elements are configured to generate a modified sound field, the modified sound field having a predetermined acoustic impedance value.

Further advantageously, data is proposed, wherein the data elements are configured to be converted into a corresponding electrical signal in order to be reproduced in a later step by an acoustic resonator and/or by at least one electroacoustic sound transducer.

Further advantageously, the data elements comprise impedance information.

Further advantageously, data is proposed, wherein the data comprises control data for controlling the acoustic resonator and/or the at least one electroacoustic sound transducer.

Further advantageously, data is proposed, wherein the data is being generated by one of the above-described signal processing units according to the invention.

Further advantageously, a processing unit for processing and/or reproducing the data is being proposed, wherein the data is in accordance with one of the above data variants and wherein the data processing unit is in particular a smartphone, a notebook, a laptop, a tablet PC, a personal computer, a wireless transmitter or a server.

Further advantageously, a sound transducer is proposed, wherein the sound transducer is configured to reproduce a generated signal by a signal processing unit according to one of the above embodiments and/or data according to one of the above embodiments.

Further advantageously, a software product that can be stored on a storage medium and processed by an electronic data processing unit to implement a signal processing unit according to one of the above embodiments and/or to generate or reproduce data according to one of the above embodiments. According to the invention, a method for acoustic reproduction is proposed, the method comprising the following steps: generating a first sound field and generating a second signal for acoustic interaction with the first sound field in order to generate a modified sound field, wherein the modified sound field has a predetermined acoustic impedance value.

Thus, according to the invention, information about the sound field impedance at the ear input is also taken into account in addition to the sound pressure, in order to reliably obtain spectral information for sound source localization even with correlated signals from the median level. However, the hearing can only derive such impedance information from the position of the eardrum at the end of the auditory canal.

The invention is characterized in particular by the fact that a headphone or earphone according to the invention not only simulates the sound pressure signal, but also the sound field impedance generated by a distant sound source on the ear in order to improve or completely avoid negative phenomena such as the IHL or SLD. In contrast to the current binaural technology, the headphones ideally do not receive a sound pressure signal that contains head-related sound pressure frequency responses, as these develop by themselves if the sound field impedance in the headphones is set correctly. The so-called head-related transfer function (HRTF) then only describes the relationship between the two ears. The procedure below describes how the sound field impedance, which is considered relevant for hearing, is defined and how it can be measured.

According to the invention, a method for measuring head-related sound field impedances of headphones is proposed.

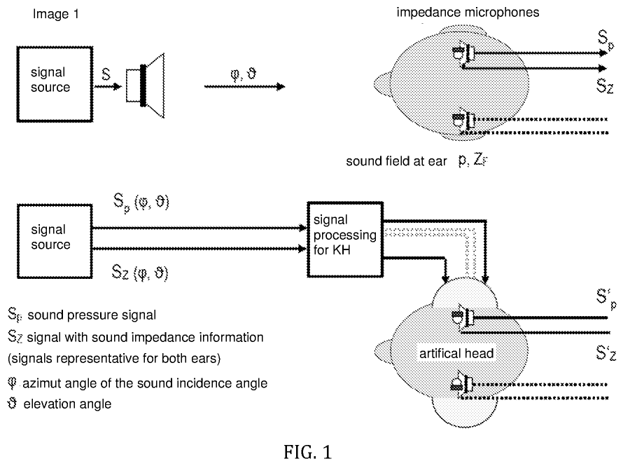

For the development of a headphone, a measurement method is necessary that indicates whether a headphone generates a sound field impedance which is relevant in regard to the avoidance of IHL and SLD. This is necessary if the measurement method for headphone sonification delivers the same result as with loudspeaker sonification. The proposed measuring method extends the known method for determining the head-related sound pressure transfer function (HRTF) by a second transfer function, which contains information about the sound field impedance. With the help of a suitable artificial head having at the end of each ear canal a so-called impedance microphone, which is able to provide both a pressure signal and a speed signal from a power source (see below), a test rig can be set-up which is suitable for loudspeaker and headphone sonification, in order to determine a signal Sp which depends on the sound pressure and a signal SZ which depends on the sound pressure and the sound field impedance (FIG. 1).

When the artificial head is exposed to loudspeaker sonification by signal S, the signals Sp and SZ are produced at the outputs of the microphones for the left and right ear. These signals depend on the frequency and the angle of incidence. If the artificial head is now irradiated with the same signals via headphones (with signal processing, if applicable), the signals S′P and S′Z are measured.

The following applies to headphones that are also supplied with the signal Sp and that simulate sound field conditions comparable to a loudspeaker on the ear:

S′p=k Sp and S′Z=k SZ.

It should be noted that the test rig for the headphones does not have to be an artificial head. A comparable measurement method, which is, however, limited to sound pressure, has been used in binaural technology for a long time in order to generate spatially perceptible sound fields in headphones. A sound pressure transfer function Hp can be determined from the measured signal Sp, which no longer contains the loudspeaker frequency response by relating the head-related signals to the pressure signals of a free-field measurement without a head:

Hp=pEar/pFree-field

Hp describes the change in sound pressure caused by the presence of a human head (body) and the relationship between the ears. This function, which is also referred to in the current binaural technology as the head-related transfer function (or HRTF), must, however, be corrected in a new headphone with sound field impedance reproduction by the sound pressure which is generated by this field impedance. Ideally, HP then only contains interaural relationships.

The signal SZ is new and provides, in comparison to the pure sound pressure signal Sp, additional information about the sound field in front of the ear. It describes the acoustic resistance at the ear entrance of a human head which is felt by a force source Q located in the ear canal if it exerts a force FQ against an external sound field. The force FQ is derived from the pressure in the ear canal by a suitable mechanism (a microphone, not described in more detail) and reacts in phase with the pressure on the sound field. For this reason, the signal SZ also depends on the sound pressure. The force source Q is itself exposed to the force FF of the external sound field. The force source Q thus impresses a force DFQ=FQ−FF into the sound field and reacts with the speed vQ to the sound field impedance ZF. Thus, vQ is therefore generally a function of sound pressure p and sound field impedance ZF: vQ=f(p, ZF)

Similar to the head-related sound pressure transfer function Hp, an impedance transfer function Hz can be determined from the signal vQ by relating vQ to the signal of a free-field measurement without head:

HZ=vQ−ear/vQ−free-field

HZ thus represents an extension of the previous head-related properties and can be used to characterize the properties of headphones with regard to the acoustic sound field impedance in front of the ear.

The application of the described method for measuring the signal SZ combined with a pressure sensor is referred to as an impedance microphone. It is able to deliver both a sound pressure signal and a signal based on the sound field impedance.

According to the invention, sound field impedance measurements are carried out on the outer ear of a test person with the aid of the 2-microphone method in order to characterize the differences in the sound irradiation with headphones and loudspeakers. With this, correlations to the subjective hearing sensations IHL and SLD are also examined. It turned out that a measurement of the X-component of the sound field impedance depicts the differences quite well and gives an idea about the value and the frequency dependency and angle dependency of the sound field impedance.

These impedance measurements are not identical to those made from the ear canal using impedance microphones and the method described above. They only apply to one component of the sound field in front of the ear.

According to the invention, the following methods for influencing the sound field impedance in front of the ear in a headphone or earphone are provided.

For a headphone or earphone that is characterized by an improvement in the localization in the median plane, in particular with regard to the frontal location, the sound field conditions in front of the ear of a human head are to be modeled as if exposed to sound from a distant sound source. Ideally, a head-related impedance signal and a frequency-independent sound pressure signal are transmitted to the headphones. An oscillation converter outputs a proportional speed signal to the headphone chamber and generates the corresponding head-related sound pressure at the specified sound field impedance. Alternatively, simplified systems can also be useful, in which the most important properties of the real sound field impedance at the ear are transmitted to a headphone.

An embodiment according to the invention with modeling approximating reality is characterized by one or more of the following properties:

a) the sound field impedance in front of the ear should have a predominantly positive reactance in the frequency range from approximately 100 Hz to 2.5 kHz and/or

b) in the case of sound from a distant sound source from the front direction, two typical sound pressure minima arise at the ear. They are usually in narrow frequency ranges around 1 kHz and 2.5 kHz, depending on the head and body geometry. These arise from minima in the sound field impedance as a result of interference. According to the invention, these sound pressure minima are not transferred to the headphones as a sound pressure signal, rather the headphones must adopt the corresponding sound field impedance, so that these sound pressure minima arise as a result thereof and/or

c) in order to realize directional hearing in the entire median plane, the minima in the sound field impedance are shifted to low frequencies with increasing sound incidence angle, in accordance with what happens at the head in case of sonication with a distant sound source. When sound comes from behind, the minima in the sound field impedance are strongly damped or disappear completely and/or

d) according to the invention, in particular a calibration option is implemented on the headphones in order to be able to optimally compensate for individual differences between listeners. This can include the magnitude of the sound field impedance as well as the location of the characteristic minima.

The apparatus, procedures and methods according to the invention which are able to influence the sound field impedance of a headphone are presented below.

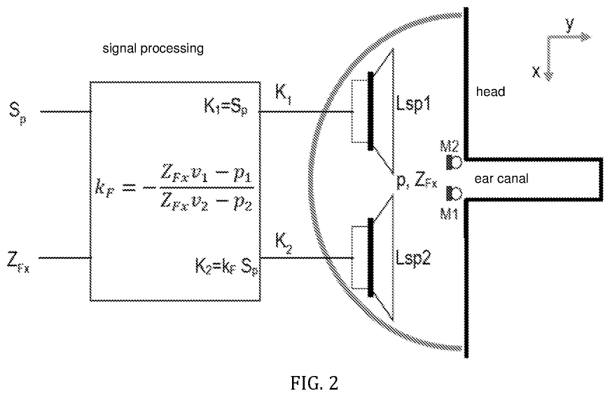

According to an embodiment of the invention and with reference to FIG. 2, the sound field impedance is modeled using pairs of sound transducers. For this purpose, according to the invention, in addition to the sound pressure at the ear, a certain sound field impedance is achieved by using two sound transducers in one headphone capsule. With suitable signal processing, the desired sound field impedance can be influenced in the arranged direction. For this purpose, the sound pressures p1, p2 and the sound velocities v1, v2 of the individual sound transducers are first determined through a suitable impedance measurement method (2-microphone method) or through previously determined sound pressures and sound fasts based on geometry-related values. A factor kF can then be calculated therefrom which describes the signal difference between the two sound transducers. Several directions can be influenced by arranging additional loudspeaker pairs in other directions. FIG. 8 shows a simple principle with a signal conditioning that calculates the signal K2 for the second loudspeaker based on the value of the sound field impedance at the input. The signal processing can also be part of a computer simulation if ZFx changes over time, such as with moving sound sources or when using head trackers. p1, p2 and v1, v2 are determined from individual measurements of the sound transducers Lsp1,2 using the 2-microphone method. Sp is the sound pressure signal and ZFx is the impedance information.

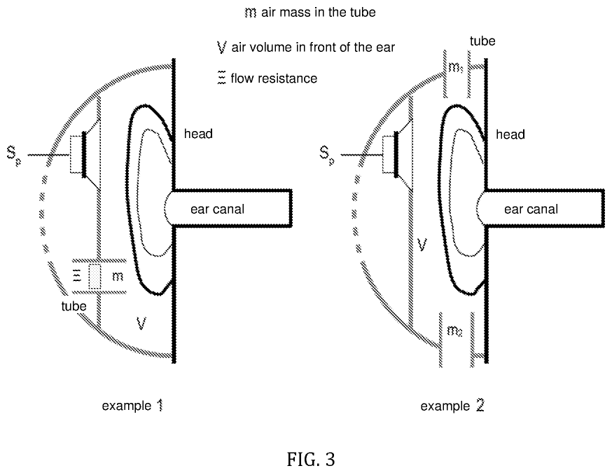

According to a further embodiment of the present invention and with reference to FIG. 3, modeling of the sound field impedance with passive acoustic resonators is proposed. With the help of Helmholz resonators, the sound field impedance in headphones can be changed to positive reactances. The resonator consists of a tube with an arbitrarily shaped cross-sectional area, the opening of which protrudes into the volume between the ear and the sound transducer. Other resonators may be used instead. The accelerated air in the tube represents a mass that, together with the stiffness of the air volume, forms a resonance system. Above the resonance frequency. The mass character of the sound field occurs above the resonance frequency. The bandwidth and quality of the system can also be influenced with a flow resistance. Several resonators in combination can also be implemented.

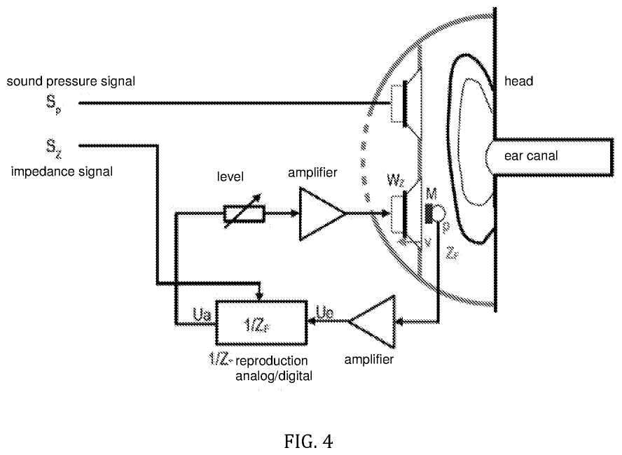

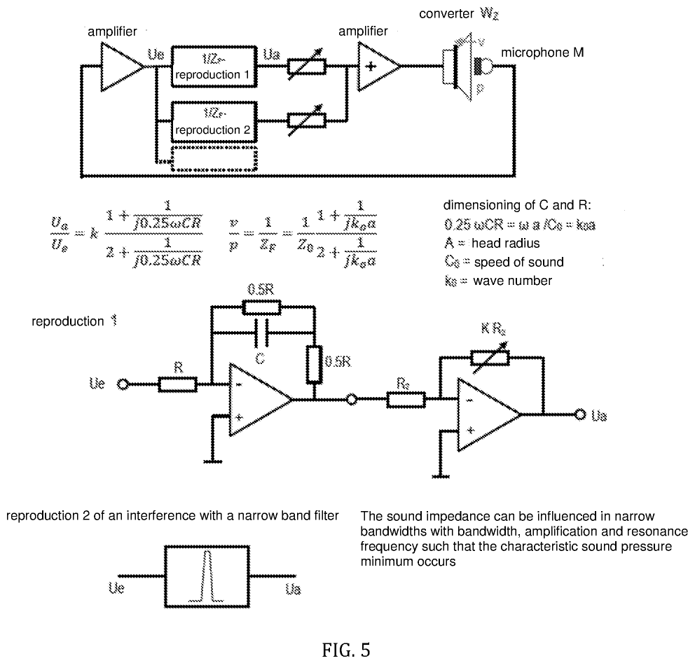

According to a further embodiment and with reference to FIG. 4, modeling of the sound field impedance with active electroacoustic systems is provided. A system consisting of a microphone, sound transducer, amplifier and a reproduction function can be used to model acoustic impedances. Simple examples that can be realized analogously are masses, springs, flow resistances or resonators. Digital networks are considerably more versatile but require very low latencies. The principle is based on the modeling of the relationship between pressure and speed in the KH pressure chamber. The pressure signal proportionality of the microphone M and the signal membrane speed proportionality of the transducer WZ are important for the correct functioning. A reproduction function describes the reciprocal of the desired acoustic impedance ZF in the form of a transfer function Ua/Ue=v/p=l/ZF. The reproduction function reacts to the pressure signal at the input with a speed signal at the output. This signal controls the converter WZ, the membrane of which operates at a proportional speed. If the amount of moved air is large enough, it determines the sound field in the headphones. The reproduction can also have a further input with which the form of the transfer function can be controlled. In the following, and with reference to FIG. 5, an embodiment for a function for analog reproduction of sound field impedances in the headphones is shown. In a first approximation, the sound field at the ear of the human head in the free sound field and at low frequencies can be described as a plane wave and a scattered wave that is reflected by a sphere that is regarded as “breathing”.

A sound pressure is generated at the radiation impedance of the “breathing” ball, which is superimposed on the plane wave. The resulting sound field impedance ZF is:

$$Z F = \frac{p}{v} = {Z}_{0} \frac{2 + \frac{1}{{fk}_{0} a}}{1 + \frac{1}{{fk}_{0} a}}$$

The following example shows what an analog replica of 1/ZF can look like. The example shows an additional reproduction 2 of an interference which leads to a minimum in the sound pressure.

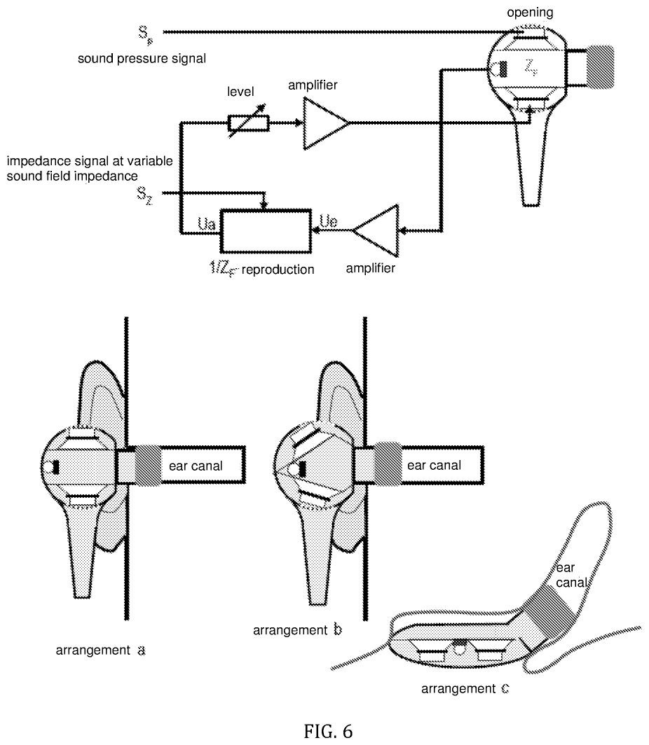

Further according to the invention and with reference to FIG. 6, an earphone is proposed. The active electroacoustic systems for influencing the sound field impedance are particularly interesting for earphones. The design of the earphones is important here, since two sound transducers and a microphone are to be accommodated in such a space-saving manner that they can still be comfortably worn by the listener. Various arrangements of the sound transducers in an earphone are also shown in FIG. 6.

1. An apparatus for acoustic reproduction, wherein the apparatus is provided with a first electroacoustic sound transducer for generating a sound field, the first electroacoustic sound transducer comprising an input for receiving an electrical signal for generating the corresponding sound field, characterized in that the apparatus further comprises a device which is configured to enter into an acoustic interaction with the generated sound field of the first electroacoustic sound transducer in order to generate a modified sound field, wherein the modified sound field has a predetermined acoustic impedance value.

2. The apparatus according to claim 1, wherein the device is at least one acoustic resonator and/or at least one further electroacoustic sound transducer.

3. The apparatus according to claim 1 or 2, wherein the first electroacoustic sound transducer and/or the further electroacoustic sound transducer is configured to receive an electrical signal based on an impedance information and to convert it into an acoustic signal so that the modified acoustic field has a predetermined acoustic impedance value through the corresponding acoustic interaction.

4. The apparatus according to claim 2, wherein the at least one acoustic resonator is designed as a recess or as a Helmholtz resonator, these being implemented particularly at the housing of the apparatus.

5. The apparatus according to one of the preceding claims, wherein the first electroacoustic sound transducer and/or the further electroacoustic sound transducer and/or the acoustic resonator are controllable by a corresponding electrical signal in order to set different acoustic impedance values in the modified sound field.

6. The apparatus according to one of the preceding claims, wherein the apparatus has a measuring unit, in particular a microphone for measuring a sound field parameter in order to be able to derive a given impedance value in the sound field therefrom, to enable the generation of a subsequent electrical adaptation signal.

7. The apparatus according to one of the preceding claims, wherein the apparatus is designed as headphones or as earphones.

8. The apparatus according to one of the preceding claims, wherein the position and/or the orientation of the first electroacoustic sound transducer and/or of the further electroacoustic sound transducer and/or of the acoustic resonator is designed to be changeable and in particular can be changed by a suitable electrical signal and adjusted if necessary.

9. A signal processing unit for processing signals for acoustic reproduction, characterized in that the signal processing unit is configured to process a further signal for acoustic interaction with a first sound field, based on a first signal which is provided for generating the first sound field, to generate a modified sound field, wherein the modified sound field has a predetermined acoustic impedance value.

10. The signal processing unit according to claim 9, wherein the signal processing unit provides a factor based on at least one sound pressure signal and/or one sound velocity of the first signal to generate a modified sound field, wherein the modified sound field has a predetermined acoustic impedance value.

11. The signal processing unit according to claim 10, wherein the sound pressure signal and/or the sound velocity is derived by a measurement, particularly from of at least one microphone.

12. The signal processing unit according to one of claims 9 to 11, wherein the signal processing unit is configured to process an impedance signal for the impedance signal being providable to a sound transducer.

13. The signal processing unit according to one of claims 9 to 12, wherein the modified sound field has a temporally predetermined variable acoustic impedance value.

14. The signal processing unit according to one of claims 9 to 13, wherein the signal processing unit is configured to process further relevant acoustic parameters, in particular geometric parameters of a headphone or an earphone, in order to set the predetermined acoustic impedance value for the modified sound field.

15. Data for acoustic reproduction, characterized in that the data has data elements for acoustic interaction with a first sound field, wherein the data elements are configured to generate a modified sound field, the modified sound field having a predetermined acoustic impedance value.

16. The data of claim 15, wherein the data elements are configured to be converted into a corresponding electrical signal in order to be reproduced in a later step by an acoustic resonator and/or by at least one electroacoustic sound transducer.

17. The data of claim 15 or 16, wherein the data elements comprise impedance information.

18. The data according to one of claims 15 to 17, wherein the data comprises control data for controlling the acoustic resonator and/or the at least one electroacoustic sound transducer.

19. Data generated by one of the signal processing units according to one of claims 9 to 14.

20. A processing unit for processing and/or reproducing the data according to claims 15 to 19, in particular a smartphone, a notebook, a laptop, a tablet PC, a personal computer, a wireless transmitter or a server.

21. A sound transducer configured to reproduce a generated signal by a signal processing unit according to one of claims 9 to 14 and/or data according to one of claims 15 to 19.

22. A software product which can be stored on a storage medium and processed by an electronic data processing unit to implement a signal processing unit according to one of claims 9 to 14 and/or to generate or reproduce data according to one of claims 15 to 19.

23. A method for acoustic reproduction, the method comprising the following steps:
generating a first sound field,
generating a second signal for acoustic interaction with the first sound field in order to generate a modified sound field, wherein the modified sound field has a predetermined acoustic impedance value.
